(19) United States
(12) Patent Application Publication
(10) Pub. No.: US 2003/0187943 A1
(43) Pub. Date: Oct. 2, 2003

(54) Mail distribution device, mail server device, client device, mail distribution program storage medium, mail server program storage medium, and client program storage medium

(75) Inventors: Yukio Ochiai, Inagi (JP); Hideki Nakatani, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/255,650

(22) Filed: Sep. 27, 2002

(30) Foreign Application Priority Data
Feb. 21, 2002 (JP) 2002-045282

(51) Int. Cl. G06F 15/16

(52) U.S. Cl. 709/207; 709/206

(57) ABSTRACT

A distributing received-mail to client device stores distribution rules in advance, receives mails from a received-mail server, collates the received mails with the distribution rules, and distributes the collated mails to each mail client.

### BACKGROUND OF THE INVENTION

1. Field of the Invention

The present invention relates to a mail distribution device distributing mails, a mail server device collecting and forwarding mails, a client device sending and receiving mails, a mail distribution program storage medium storing a mail distribution program that causes a computer to operate as the mail distribution device, a mail server program storage medium storing a mail server program that causes a computer to operate as the mail server device, and a client program storage medium storing a client program that causes a computer to operate as the client device.

2. Description of the Related Art

In recent years, systems for sending and receiving electronic mails using communication lines such as the Internet etc. spread widely. What appeared together with the spread of such systems are various desires like using two or more clients (programs for sending and receiving mails) according to mail attributes such as private use, business use, etc., trying to use another mail client (mail program) different from the one currently being used, or receiving mails sent from a specific mail client (mail program) only by a specific mail client (mail program) in order to use functions effective only in sending/receiving mails between predetermined mail clients (mail programs).

Conventionally, solutions as described below have been adopted to satisfy the above desires.

(1) For the desire of distributing mails to plural mail clients according to mail attributes (for example, private use, business use, etc.), by respectively associating the mail clients with different plural mail addresses held by a user, mails sent to a specific mail address are received by a specific mail client.

(2) For the desire of using one mail address regardless of mail attributes, by setting that mails in a mail server should not be deleted even after they are sent to a client, mails sent to the one mail address are received by plural mail clients.

However, as to the above (1), burdensome work for managing plural mail addresses is required. Also, a sender of mails may force burdensome work on receivers who have the relationship with the sender in both private and business because there are cases where they need to handle plural mail addresses of the sender according to mail attributes.

Also, as to the above (2), it takes time to receive mails since every mail client executing the mail-receiving process receives all the mails sent to the one mail address. In addition, it takes time and is burdensome to divide the received mails into necessary ones and unnecessary ones. Further, it is necessary for the mail server to keep the mails sent to the one mail address until all the mail clients that need to receive the mails finish receiving them, which gives a burden on the mail server.

### SUMMARY OF THE INVENTION

In view of the above circumstances, it is an object of the present invention to provide a mail distribution device in which burdensome work in distributing mails is avoided, a mail server device having a mail distributing function, a client device having a mail distributing function, a mail distribution program storage medium storing a mail distribution program that causes a computer to operate as the above mail distribution device, a mail server program storage medium storing a mail server program that causes a computer to operate as the mail server device having the mail distributing function, and a client program storage medium storing a client program that causes a computer to operate as the client device having the mail distributing function.

To obtain the above object, a mail distribution device according to the present invention comprises: a rule storage section storing distribution rules for distributing mails to plural pieces of mail software at least receiving mails; and a mail distribution section distributing mails to each piece of mail software according to the distribution rules stored in the rule storage section.

The mail distribution device according to the present invention stores distribution rules for distributing mails to plural pieces of mail software at least performing receipt of mails between receipt of mails and transmission of mails, and distributes mails according to the distribution rules. Only by setting distribution rules once, mails are automatically distributed thereafter, and therefore, operation like selecting one from plural mail addresses and judging whether mails are necessary or not one by one so that a user can delete unnecessary mails is cut out in order to avoid burdensome work.

Here, in the mail distribution device according to the present invention, it is preferable that the rule storage section stores distribution rules including a discard rule for discarding mails without distribution, and that the mail distribution section discards mails corresponding to the discard rule without distribution.

Accordingly, mails that do not need to be distributed are automatically discarded, and thus burdensome work is avoided further.

It is possible to provide various modes of the mail distribution device according to the present invention in systems of sending and receiving mails. For example, the mail distribution device can be incorporated in a mail server that processes mails or a client that sends and receives mails, or can be located between a mail server and client.

A mail distribution device of the mode in which it is located between a mail server and client comprises: a mail receiving section receiving mails from a mail server; a rule storage section storing distribution rules for distributing the received mails to plural clients at least receiving mails; a mail distribution section distributing the mails received by the mail receiving section according to the distribution rules stored in the rule storage section to each client; and a mail sending section sending the mails distributed by the mail distribution section to each client as a distribution destination.

Here, the above-mentioned “client” may be not only the concept including hardware such as a client machine etc., but also the concept that is synonymous with mail software. This allowance is adopted in the following, as long as it is not contrary to the feature of each mode.

Also, a mail server device that has a configuration in which a mail distributing function is incorporated in a mail server, processes mails, and comprises: a rule storage section storing distribution rules for distributing mails to plural clients at least receiving mails, in which a distribution rule is associated with one receiver address; a mail distribution section, for the time of sending mails having the same receiver address as that of the distribution rule stored in the rule storage section, distributing the mails to a client according to the distribution rule associated with the receiver address and stored in the rule storage section; and a mail sending section sending the mails to the client to which the mails have been distributed by the mail distribution section.

Further, a client device that has a configuration in which a mail distributing function is incorporated in a client, allows plural pieces of mail software at least receiving mails to operate, and comprises: a rule storage section storing distribution rules for distributing mails to the plural pieces of mail software; and a mail distribution section distributing the received mails to each mail software according to the distribution rules stored in the rule storage section.

Furthermore, to obtain the above object, the present invention provides a mail distribution program storage medium storing a mail distribution program that is executed in a computer and causes the computer to operate as a mail distribution device, in which the mail distribution device comprises: a rule storage section storing distribution rules for distributing mails to plural pieces of mail software at least receiving mails, and a mail distribution section distributing mails to each piece of mail software according to the distribution rules stored in the rule storage section.

Here, in the mail distribution program stored in the mail distribution program storage medium according to the present invention, it is preferable that the rule storage section stores distribution rules including a discard rule for discarding mails without distribution, and that the mail distribution section discards mails corresponding to the discard rule without distribution.

The mail distribution program stored in the mail distribution program storage medium includes, like the above-described mail distribution device, any of the following modes: a mode in which the mail distribution program is installed and executed in a computer operating as a mail server; a mode in which the mail distribution program is installed and executed in a computer operating as a client; and a mode in which the mail distribution program is installed and executed in a device located between a mail server and client.

As to the mode in which the mail distribution program located between a mail server and client, there is provided a mail distribution program storage medium storing a mail distribution program that is executed in a computer and causes the computer to operate as a mail distribution device, wherein the mail distribution device comprises: a mail receiving section receiving mails from a mail server; a rule storage section storing distribution rules for distributing the received mails to plural pieces of mail software at least receiving mails; a mail distribution section distributing the mails received by the mail receiving section according to the distribution rules stored in the rule storage section to each mail software; and a mail sending section sending the mails distributed by the mail distribution section to each mail software as a distribution destination.

Also, as to the mode in which the mail server program is installed and executed in a mail server, there is provided a mail server program storage medium storing a mail server program that is executed in a computer and causes the computer to operate as a mail server, wherein the mail server device comprises: a rule storage section storing distribution rules for distributing mails to plural clients at least receiving mails, in which a distribution rule is associated with one receiver address; a mail distribution section, for the time of sending mails having the same receiver address as that of the distribution rule stored in the rule storage section, distributing the mails to a client according to the distribution rule associated with the receiver address and stored in the rule storage section; and a mail sending section sending the mails to the client to which the mails have been distributed by the mail distribution section.

Furthermore, as to the mode in which the client program is installed and executed in a client, there is provided a client program storage medium storing a client program that is executed in a computer and causes the computer to operate as a client, wherein the client device comprises: a rule storage section storing distribution rules for distributing mails to the plural pieces of mail software; and a mail distribution section distributing the received mails to each mail software according to the distribution rules stored in the rule storage section.

### BRIEF DESCRIPTION OF THE DRAWINGS

FIG. 1 is a schematic view showing a mailing system that performs sending and receiving mails.

FIG. 2 is a view showing a hardware configuration of a computer having the appearance shown in FIG. 1.

FIG. 3 is a schematic configuration diagram showing a mail distribution program stored in an embodiment of a mail distribution program storage medium according to the present invention.

FIG. 4 is a functional block diagram showing an embodiment of a mail distribution device according to the present invention.

FIG. 5 is a schematic configuration diagram showing a mail distribution program stored in another embodiment of a mail distribution program storage medium according to the present invention.

FIG. 6 is a schematic configuration diagram showing another embodiment of a mail distribution device according to the present invention.

FIG. 7 is an overall configuration diagram showing a mailing system including the mail distribution program shown in FIG. 5 and the mail distribution device shown in FIG. 6.

FIG. 8 is a block diagram showing a configuration of a distributing received-mail to client device constituting the mailing system shown in FIG. 7.

FIG. 9 is a diagram showing examples of a distribution rule for distributing mails.

FIG. 10 is a flowchart showing a process flow in the distributing received-mail to client device shown in FIGS. 7 and 8.

FIG. 11 is a schematic configuration diagram showing a mail server program stored in an embodiment of a mail server program storage medium.

FIG. 12 is a functional block diagram showing an embodiment of a mail server device according to the present invention.

FIG. 13 is a detail block diagram showing the mail server device shown in FIG. 12.

FIG. 14 is a schematic configuration diagram showing a client program stored in an embodiment of a client program storage medium according to the present invention.

FIG. 15 is a functional block diagram showing an embodiment of a client device according to the present invention.

FIG. 16 is a functional block diagram showing a mailing system including an embodiment of a client device according to the present invention.

FIG. 17 is a flowchart showing an operation at the time of receiving mails, performed by a mail distribution server within a client, in the mailing system shown in FIG. 16.

### DETAILED DESCRIPTION OF THE PREFERRED EMBODIMENTS

Embodiments of the present invention will be described as follows.

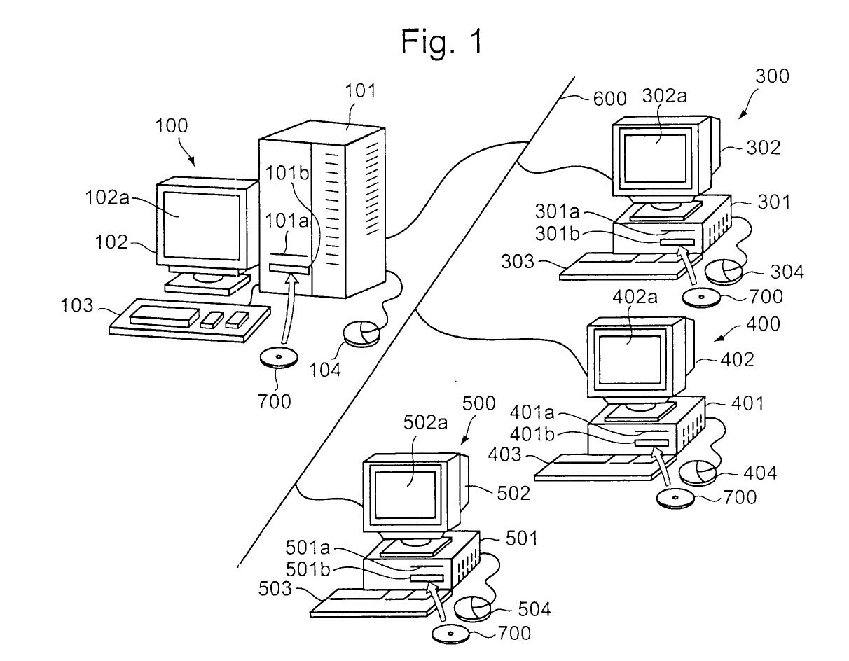

FIG. 1 is a schematic view showing a mailing system that performs sending and receiving mails.

FIG. 1 shows four typical computers 100, 300, 400 and 500 interconnected via a communication line 600. As these computers 100, 300, 400 and 500, computers generally called a workstation or a personal computer can be used. Also, as the communication line 600, any of the lines like the Internet, LAN (Local Area Network), WAN (Wide Area Network), etc. can be used, and the Internet is the one being used here.

The computer 100 among the above four computers operates as a mail server that sends and receives mails, and also, operates as an embodiment of the mail server device according to the present invention in one of the different types of modes that will be explained later. Also, as to the rest of the computers, 300, 400 and 500, respectively sending and receiving mails, each of them operates as an embodiment of the client device according to the present invention in one of the different types of modes that will be explained later.

Alternatively, in another one of the modes that will be explained later, the computer 300 operates as an embodiment of the mail distribution device that is located between a mail server and client. In this mode, the computers 400 and 500 operate as clients respectively sending and receiving mails.

First, a hardware configuration of these computers will be explained hereinafter.

The computers 100, 300, 400 and 500 respectively comprise: main sections 101, 301, 401 and 501 in each of which a CPU (Central Processing Unit), a RAM (Random Access Memory), a hard disk, a communication board, etc. are built in; display sections 102, 302, 402 and 502 which respectively display images and character strings on display screens 102a, 302a, 402a and 502a by each command of the main sections 101, 301, 401 and 501; keyboards 103, 303, 403 and 503 for inputting each user's command into the computers 100, 300, 400 and 500; and mice 104, 304, 404 and 504 for inputting each command according to icons etc. displayed on a position at the time of pointing by pointing each arbitrary position on the display screens 102a, 302a, 402a and 502a.

The respective main sections 101, 301, 401 and 501 further comprise FD loading slots 101a, 301a, 401a and 501a and CD-ROM loading slots 101b, 301b, 401b and 501b, where each floppy disk (not shown) and each CD-ROM 700 are loaded, in appearance. Inside those, each FD drive and CD-ROM drive which drive and access each floppy disk and CD-ROM 700 that are loaded from those loading slots 101a and 101b; 301a and 301b; 401a and 401b; 501a and 501b are also built in.

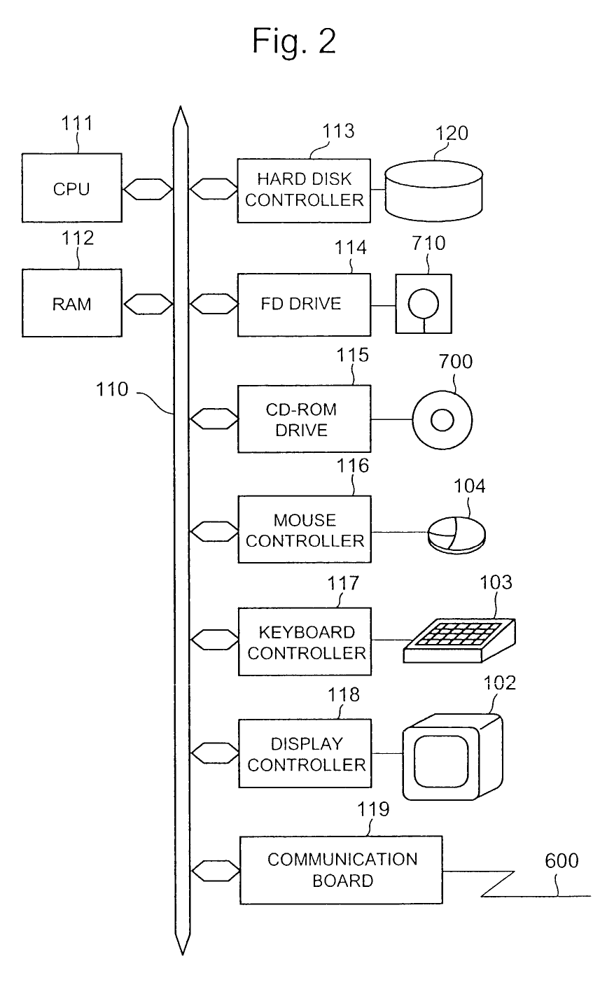

FIG. 2 is a view showing a hardware configuration of a computer having the appearance shown in FIG. 1. Here, although an explanation will be provided referring to the computer 100 as a typical example, also the computers 300, 400 and 500 each have the same configuration.

In a hardware configuration diagram shown in FIG. 2, there are CPU 111, RAM 112, a hard disk controller 113 and an FD drive 114, a CD-ROM drive 115, a mouse controller 116, a keyboard controller 117, a display controller 118, and a communication board 119, which are mutually connected via a bus 110.

As described referring to FIG. 1, the FD drive 114 and the CD-ROM drive 115 access an FD 710 and the CD-ROM 700 loaded from the FD loading slot 101a and the CD-ROM loading slot 101b respectively. The communication board 119 is connected to the communication line 600.

Also, in FIG. 2, a hard disk 120 accessed by the hard disk controller 113, the mouse 104 controlled by the mouse controller 116, the keyboard 103 controlled by the keyboard controller 117, and the display section (a CRT display) 102 controlled by the display controller 118 are also shown.

The CD-ROMs 700 as a mail distribution program storage medium, a mail server program storage medium and a client program storage medium according to the present invention respectively storing a mail distribution program, a mail server program and a client program are loaded into the CD-ROM loading slots 101b, 301b, 401b and 501b of the above-described respective computers. As a result, these programs stored in the CD-ROMs 700 are installed in the computers corresponding to the respective embodiments among the computers 100, 300, 400 and 500.

Note that each program storage medium according to the present invention is not limited to a CD-ROM as described above. Any kinds of storage medium such as DVD, CompactFlash (trademark) memory, SmartMedia, Memory Stick, etc. may be used as long as a computer can read the contents stored therein.

Alternatively, those programs may be downloaded via the communication line 600 in the computers corresponding to the respective embodiments.

Each of those programs may be stored beforehand in a storage medium (a hard disc, for example) built in each computer corresponding to each embodiment.

Each embodiment according to the present invention, which is configured in the system shown in FIG. 1, will be explained as follows.

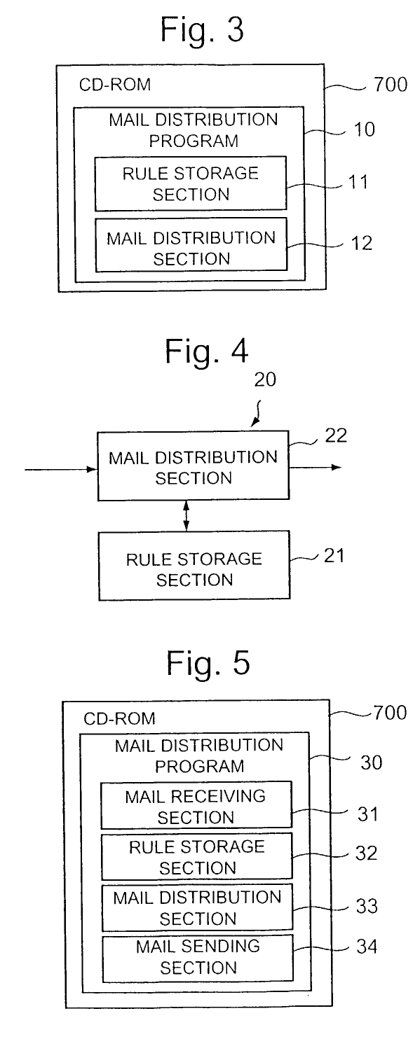

FIG. 3 is a schematic configuration diagram showing a mail distribution program stored in an embodiment of a mail distribution program storage medium according to the present invention.

A mail distribution program 10 shown in this figure has been stored in a CD-ROM 700 shown in FIG. 1. The mail distribution program 10 is a concept program, and a concrete program that will be described later is installed in a computer corresponding to the embodiment. Therefore, the explanation will be provided here without mentioning specifically which one of the computers shown in FIG. 1 is the computer in which the mail distribution program 10 is installed.

The mail distribution program 10 shown in FIG. 3 has a rule storage section 11 and a mail distribution section 12. The rule storage section 11 is a software component which, when installed and executed in a computer, writes in a hard disk (refer to the hard disk 120 shown in FIG. 2) of the computer a mail distribution rule for mails having the same receiver address, and reads out the distribution rule stored therein. The mail distribution rule will be specifically explained later using examples. Also, the mail distribution section 12 is a program component which distributes mails according to the mail distribution rule written in the hard disk of the computer by the rule storage section 11.

FIG. 4 is a functional block diagram showing an embodiment of a mail distribution device according to the present invention. A mail distribution device 20 shown in FIG. 4 is configured in a computer as a result of that the mail distribution program 10 shown in FIG. 3 is installed and executed in that computer.

The mail distribution device 20 shown in FIG. 4 has a rule storage section 21 and a mail distribution section 22. The rule storage section 21 is a storage section that stores a mail distribution rule for mails having the same receiver address and is configured in a hard disk of the computer in the present embodiment.

Also, the mail distribution section 22 of the mail distribution device 20 shown in FIG. 4 distributes mails according to the distribution rule stored in the rule storage section 21.

FIG. 5 is a schematic configuration diagram showing a mail distribution program stored in another embodiment of a mail distribution program storage medium according to the present invention.

A mail distribution program 30 has been stored in a CD-ROM 700 shown in FIG. 1, and is supposed to be installed in the computer 300 shown in FIG. 1. When the mail distribution program 30 shown in FIG. 5 is installed and executed in the computer 300 shown in FIG. 1, the computer 300 operates as a mail distribution device that intervenes between a mail server (computer 100) sending and receiving mails and a client (computers 400 and 500) sending and receiving mails, and distributes mails.

The mail distribution program 30 shown in FIG. 5 has a mail receiving section 31, a rule storage section 32, a mail distribution section 33, and a mail sending section 34.

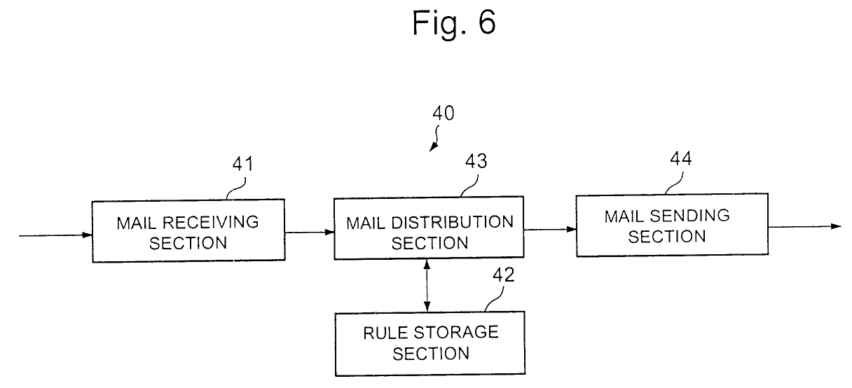

Operations of the respective sections in the mail distribution program 30 will be explained together with those of the respective sections in a mail distribution device shown in FIG. 6.

FIG. 6 is a schematic configuration diagram showing another embodiment of a mail distribution device according to the present invention. A mail distribution device 40 shown in FIG. 6 is configured in the computer 300 shown in FIG. 1 as a result of that the mail distribution program 30 shown, in FIG. 5 is installed and executed in that computer.

It is assumed that, for a mailing system including the mail distribution device of the present embodiment, besides that the mail distribution program 30 shown in FIG. 5 has been installed in the computer 300, a program for making the computer 100 operate as an ordinary mail server has been installed in the computer 100, and a program making each of the computers 400 and 500 operate as an ordinary mail client has been installed in each of these computers 400 and 500.

The mail distribution device 40 shown in FIG. 6 has a mail receiving section 41, a rule storage section 42, a mail distribution section 43 and a mail sending section 44.

The mail receiving section 41 receives mails from a mail server (computer 100 shown in FIG. 1). While the mail receiving section 41 shown in FIG. 6 is composed of hardware of the computer 300 and software executed there, the mail receiving section 31 shown in FIG. 5 as a program component is configured only by an application program portion of these hardware and software.

Also, the rule storage section 42 shown in FIG. 6 stores distribution rules for distributing the received mails to plural clients that send and receive mails (two computers 400 and 500 as examples in FIG. 1). The rule storage section 31 as a program component shown in FIG. 5 is configured by an application program which, when executed in the computer 300, stores mail distribution rules in the computer 300 as well as reads out the distribution rules as necessary.

In addition, the mail distribution section 43 shown in FIG. 6 distributes the mails received by the mail receiving section 41 to each client (computers 400 and 500 shown in FIG. 1) according to the distribution rules stored in the rule storage section 42. While the mail distribution section 43 shown in FIG. 6 is composed of hardware of the computer 300 and software executed there, the mail distribution section 33 as a program component shown in FIG. 5 is configured only by an application program portion of these hardware and software.

Further, the mail sending section 44 shown in FIG. 6 sends the mails distributed by the mail distribution section 43 to each client (computers 400 and 500 shown in FIG. 1) as a destination of the distributed mails. Just like the mail distribution section 43, while the mail sending section 44 is composed of hardware of the computer 300 and software executed there, the mail sending section 34 in FIG. 5 is configured only by an application program portion of these hardware and software.

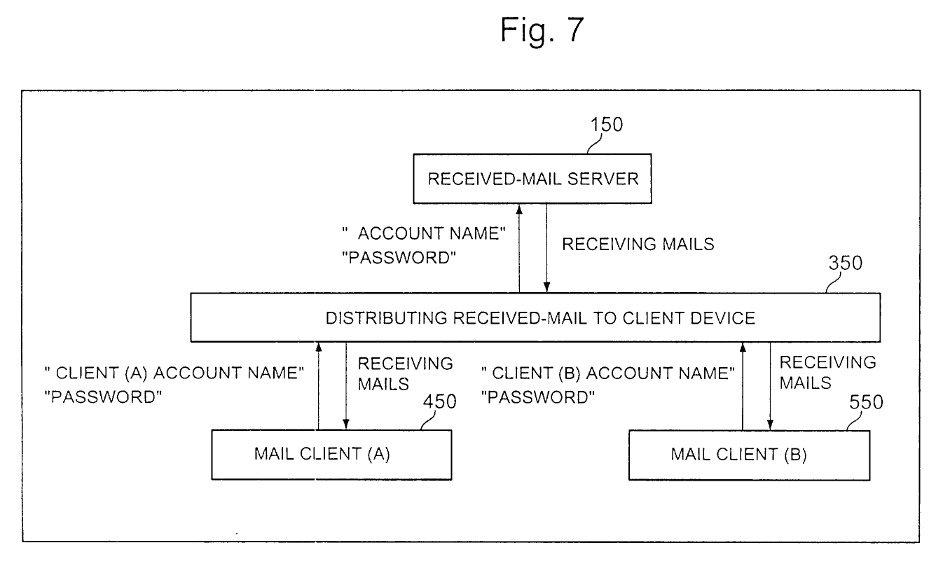

FIG. 7 is an overall configuration diagram showing a mailing system including the mail distribution program 30 shown in FIG. 5 and the mail distribution device 40 shown in FIG. 6.

The mailing system shown in FIG. 7 is composed of a received-mail server 150, a distributing received-mail to client device 350, a mail client (A) 450 and a mail client (B) 550.

With respect to the correspondence relation to FIG. 1, the received-mail server 150 corresponds to the computer 100 in FIG. 1, the distributing received-mail to client device 350 corresponds to the computer 300 in FIG. 1 and the mail distribution device 40 shown in FIG. 6, the mail client (A) 450 corresponds to the computer 400 shown in FIG. 1, and the other mail client (B) 550 corresponds to the computer 500 shown in FIG. 1.

In the present embodiment, as shown in FIG. 7, mails are not sent directly from the received-mail server 150 to the mail clients 450 and 550. The distributing received-mail to client device 350 receives mails from the received-mail server 150, and the mail clients 450 and 550 receive mails from the distributing received-mail to client device 350. The distributing received-mail to client device 350 operates as a mail client for the received-mail server 150 and operates as a mail server for the mail clients 450 and 550. In FIG. 7, the distributing received-mail to client device 350 is explained as a device that exists in another place apart from the received-mail server 150 and the mail clients 450 and 550. However, as described in embodiments that will be explained later, a structure corresponding to the distributing received-mail to client device 350 can be placed within a device equal to the received-mail server 150, or within a device equal to the mail client 450 or 550.

In a conventional and general mailing system, “account name” and “password” for connecting to a received-mail server are set in a mail client. In the present embodiment, “account name” and “password” for connecting to the received-mail server 150 are set in the distributing received-mail to client device 350. Further, “account name” and “password” to be identified by the distributing received-mail to client device 350 are set in the mail clients 450 and 550 respectively.

Here, the explanation will be provided as follows using a concrete example.

It is assumed that the received-mail server 150 is functioned by mail.server.com as the name, 110 as the port No., and POP3 as the protocol, and that the account name is nakatani and the password is ***** to the received-mail server 150. In this case, the setting in the distributing received-mail to client device 350 (name: mail.furiwake.com) is as follows.

(Setting in the distributing received-mail to client device: mail.furiwake.com)

Type of received-mail server: POP3

Name of received-mail server: mail.server.com

Port No. of server: 110

Account name: nakatani

Password: *****

The mail clients 450 and 550 connect with the above distributing received-mail to client device 350.

For the distributing received-mail to client device 350 is operated as a server with the name: mail.furiwake.com, the port No.: 110, and the protocol: POP3, a concrete example is provided as shown below. Here, the values set as an account name and a password correspond to “account name” and “password” respectively. These “account name” and “password” are used by the distributing received-mail to client device, mail.furiwake.com, to identify a connecting mail client, and have been set in advance in the distributing received-mail to client device, mail.furiwake.com.

(Example of setting in the client (A))

Type of received-mail server: POP3

Name of received-mail server: mail.furiwake.com

Port No. of server: 110

Account name: nakatani_business

Password: *****

(Example of setting in the client (B))

Type of received-mail server: POP3

Name of received-mail server: mail.furiwake.com

Port No. of server: 110

Account name: nakatani_private

Password: *****

In the present embodiment, as a mechanism to send information such as ID from a mail client to a received-mail server, the distributing received-mail to client device 350 instead of the mail clients sends information such as an account name to the received-mail server 150. Accordingly, as to the two exchanges, one is the exchange between the mail clients and the distributing received-mail to client device and the other is the exchange between the distributing received-mail to client device and the received-mail server, the existing mail protocol is used as it is.

Note that sending mails from the mail clients will not be explained because the mails are sent based on conventional setting and process.

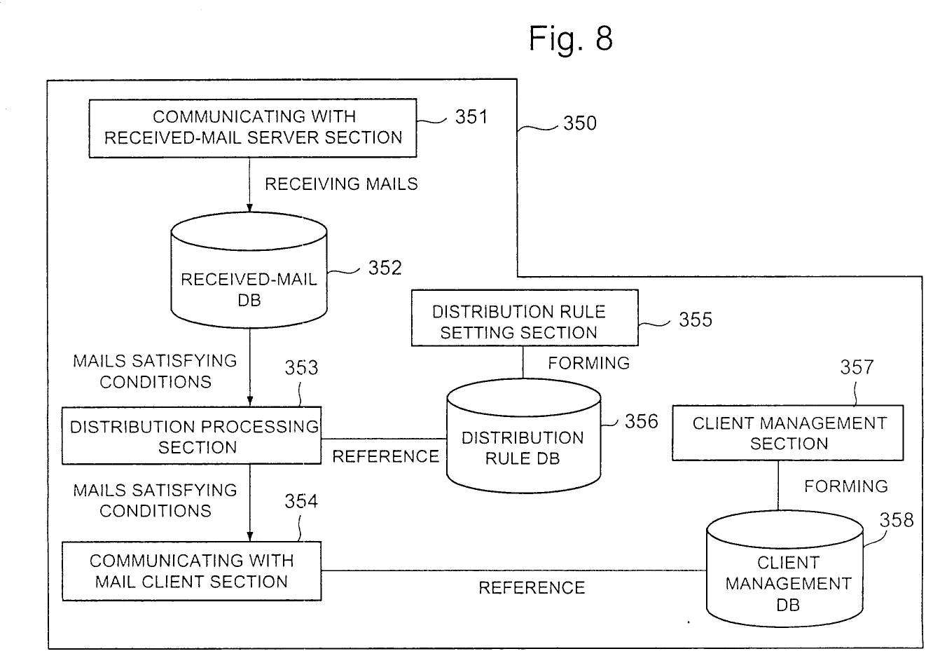

FIG. 8 is a block diagram showing a configuration of a distributing received-mail to client device constituting the mailing system shown in FIG. 7.

A communicating with received-mail server section 351 constituting the distributing received-mail to client device 350 has a function for performing communication with the received-mail server 150 (refer to FIG. 7) using “account name” and “password” to receive mails. Accordingly, the distributing received-mail to client device 350 performs as a mail client to the received-mail server 150. The mails received by the communicating with received-mail server section 351 are stored in a received-mail database (DB) 352.

Also, a distribution processing section 353 determines which mail client should receive a mail with respect to each mail, according to distribution rules stored in a distribution rule database (DB) 356. The distribution rules will be explained later.

The role of a communicating with mail client section 354 is, when a mail client gives using “account name” and “password” a request that this client should receive mails, to identify the mail client referring to a client management database (DB) 357 and to pass the mails distributed to the corresponding mail client to that mail client.

Also, a distribution rule setting section 355 sets distribution rules for distributing mails upon receiving an order from a mail client, and forms the distribution rule DB 356. The distribution rule setting section 355 may form the distribution rule DB 356 according to distribution rules set by a user through the mail client, or may create distribution rules by analogy based on the contents set by the user. For example, if a rule is set using a keyword, not only keywords given by the user but also additionally their synonyms may automatically be used.

Now, the distribution rules will be explained

The distribution rule is a rule for distribution using, for example, attributes of a mail (receipt date/time, title, sender, destination, contents, attached file, name of mail client, significance, size, etc.).

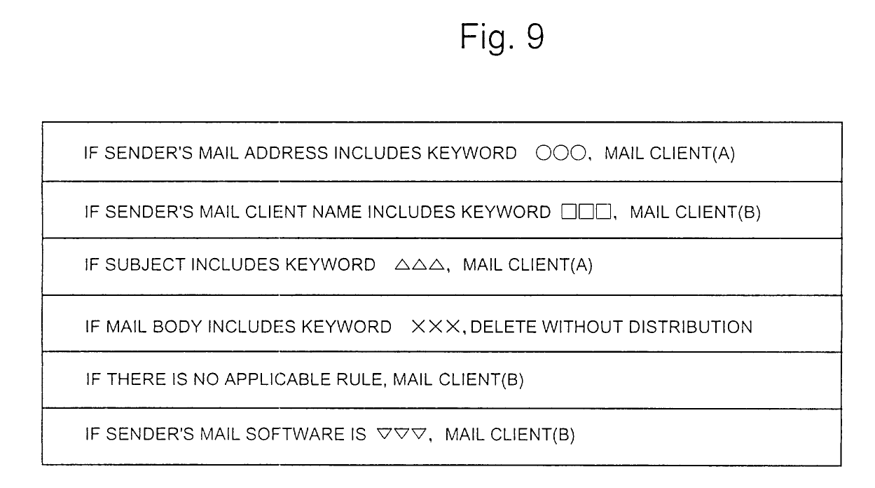

FIG. 9 is a diagram showing examples of a distribution rule for distributing mails.

As the examples shown in FIG. 9, besides rules for sending mails to any one of mail clients, there can be rules including conditions that a user wants to refuse receiving certain mails, and thereby it is possible to utilize the rules for refusing annoying mails etc. and deleting mails infected with viruses.

Also, there is a distribution rule that is “If sender's mail software is ∇∇∇, mail client (B)” among the examples shown in FIG. 9. This distribution rule means that if the sender's mail software is ∇∇∇, a mail is sent to the mail client (B) having the same type of mail software (the same product) as the mail software ∇∇∇. In this way, when such distribution rule that a mail is sent to and received by a mail client having the same mail software (the same product) as that of a sender, it is possible to send and receive mails using a function unique to that mail software. The sender's mail software type can be obtained from X-Mailer in the header of a mail.

Furthermore, a client management section 357 shown in FIG. 8 is to form a client management DB 358 by accepting “account name” and “password” set by a user through a mail client. That is, mail clients connecting with this “distributing received-mail to client device 350” need to be registered here beforehand.

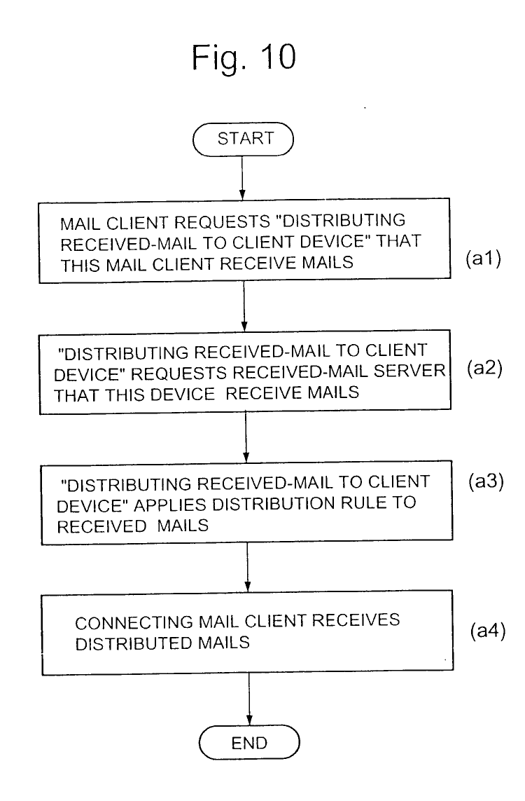

FIG. 10 is a flowchart showing a process flow in the distributing received-mail to client device 350 shown in FIGS. 7 and 8.

First, a mail client requests the distributing received-mail to client device 350 that this mail client should receive mails (step al). Here, the distributing received-mail to client device 350 identifies the client using its account name and password. That is, the distributing received-mail to client device 350 operates as a mail server to the mail client.

Next, the distributing received-mail to client device 350 requests the received-mail server that the distributing received-mail to client device 350 should receive mails (step a2). Here, the distributing received-mail to client device 350 connects with the received-mail server using its account name and password to obtain the mails that the received-mail server has received. That is, the distributing received-mail to client device 350 operates as a mail client to the received-mail server.

And then, the distributing received-mail to client device 350 applies distribution rules to the received mails (step a3). Here, according to the distribution rules, the distributing received-mail to client device 350 selects the mails that the connecting mail client should receive.

Lastly, the connecting mail client receives the mails distributed to itself (step a4).

According to the above-described embodiment, it is possible to use plural mail clients as necessary with one mail address, which can satisfy a demand for wishing to use more than one mail client by one person. Accordingly, management becomes easy because it is unnecessary to have plural mail addresses. In addition, since it is possible to use mail clients according to kinds of mail, it becomes easy to use various mail clients according to purposes.

Next, another embodiment of the present invention will be explained.

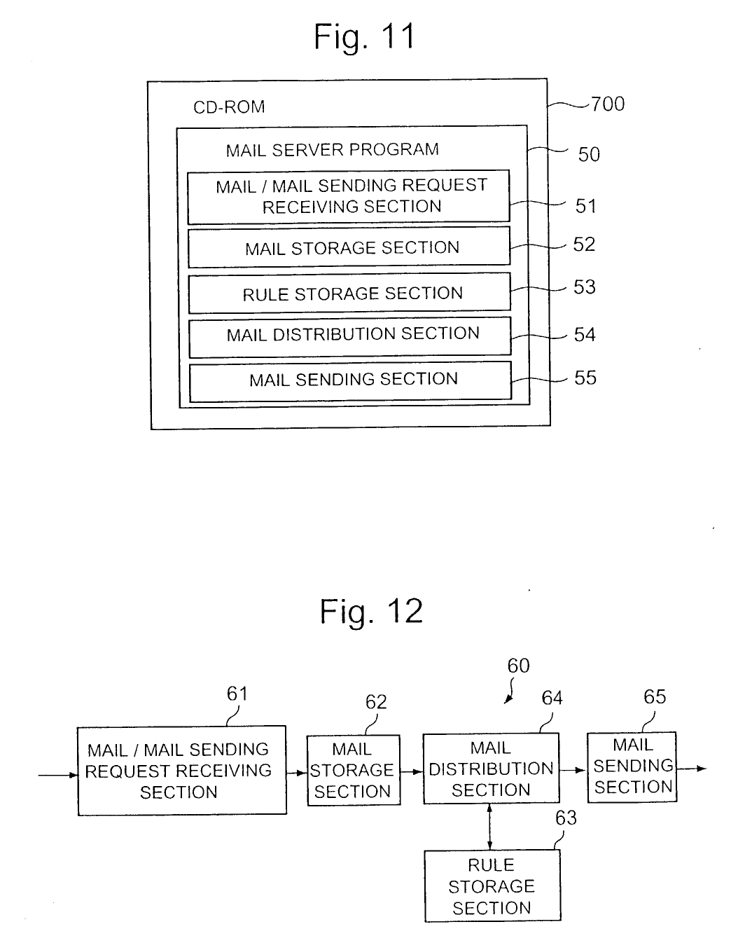

FIG. 11 is a schematic configuration diagram showing a mail server program stored in an embodiment of a mail server program storage medium.

A mail server program 50 has been stored in a CD-ROM 700 shown in FIG. 1, and is supposed to be installed in the computer 100 shown in FIG. 1. When the mail server program 50 shown in FIG. 11 is installed and executed in the computer 100 shown in FIG. 1, the computer 100 operates as an embodiment of the mail server device according to the present invention.

The mail server program 50 shown in FIG. 11 has a mail/mail sending request receiving section 51, a mail storage section 52, a rule storage section 53, and a mail sending section 55. Functions of these sections will be explained together with those of the respective sections in a mail server device shown in FIG. 12.

FIG. 12 is a functional block diagram showing an embodiment of a mail server device according to the present invention. A mail server device 60 shown in FIG. 12 is configured within the computer 100 shown in FIG. 1, when the mail server program 50 shown in FIG. 11 is installed and executed in the computer 100.

It is assumed that in a mailing system including the mail server device of the present invention, the mail server program 50 shown in FIG. 11 has been installed in the computer 100 shown in FIG. 1, and mail software for making each of the other computers 300, 400 and 500 operate as an ordinary mail client has been installed in each of these computers.

The mail server device 60 shown in FIG. 12 has a mail/mail sending request receiving section 61, a mail storage section 62, a rule storage section 63, a mail distribution section 64, and a mail sending section 65.

The mail/mail sending request receiving section 61 receives mails sent from a mail client to another mail client and passes the received mails to the mail storage section 62, and further receives requests sent from a mail client that the mails addressed to the mail client should be sent to the mail client and notifies the mail storage section 62 about the received requests.

While the mail/mail sending request receiving section 61 shown in FIG. 12 is composed of hardware of the computer 100 and software executed there, the mail/mail sending request receiving section 51 as a program component constituting the mail server program 50 shown in FIG. 11 is configured by an application program portion of these hardware and software.

Also, the mail storage section 62 shown in FIG. 12 accepts and stores the mails received by the mail/mail sending request receiving section 61. And, upon receiving a mail sending request from the mail/mail sending request receiving section 61, the mail storage section 62 sends, to the mail distribution section 64, the stored mails supposed to be sent to the mail client (having the mail client's mail address as a receiving address) which provided the mail sending request. The mail storage section 52 as a program component shown in FIG. 11 is configured by an application program which, when executed in the computer 100, stores mails in the computer 100 and reads out the stored mails as necessary.

Here, distribution rules for distributing mails having the same receiving address to plural mail clients have been stored in the rule storage section 63. And then, the mail distribution section 64 accepts the mails received by the mail/mail sending request receiving section 61 and temporarily stored in the mail storage section 62, and distributes the accepted mails according to the distribution rules stored in the rule storage section 63 to the respective mail clients.

Here, the rule storage section 53 as a program component shown in FIG. 11 is configured by an application program which, when executed in the computer 100, stores distribution rules for mails in the computer 100 and reads out the stored distribution rules as necessary. Further, while the mail distribution section 64 shown in FIG. 12 is composed of hardware of the computer 100 and software executed there, the mail distribution section 54 as a program component shown in FIG. 11 is configured only by an application program portion of these hardware and software.

Also, the mail sending section 65 shown in FIG. 12 is to send the mails distributed by the mail distribution section 64 to each client as a destination of the distributed mails. While the mail sending section 65 shown in FIG. 12 is composed of hardware of the computer 100 shown in FIG. 1 and software executed there, the mail sending section 55 as a program component shown in FIG. 11 is configured by an application program portion of these hardware and software

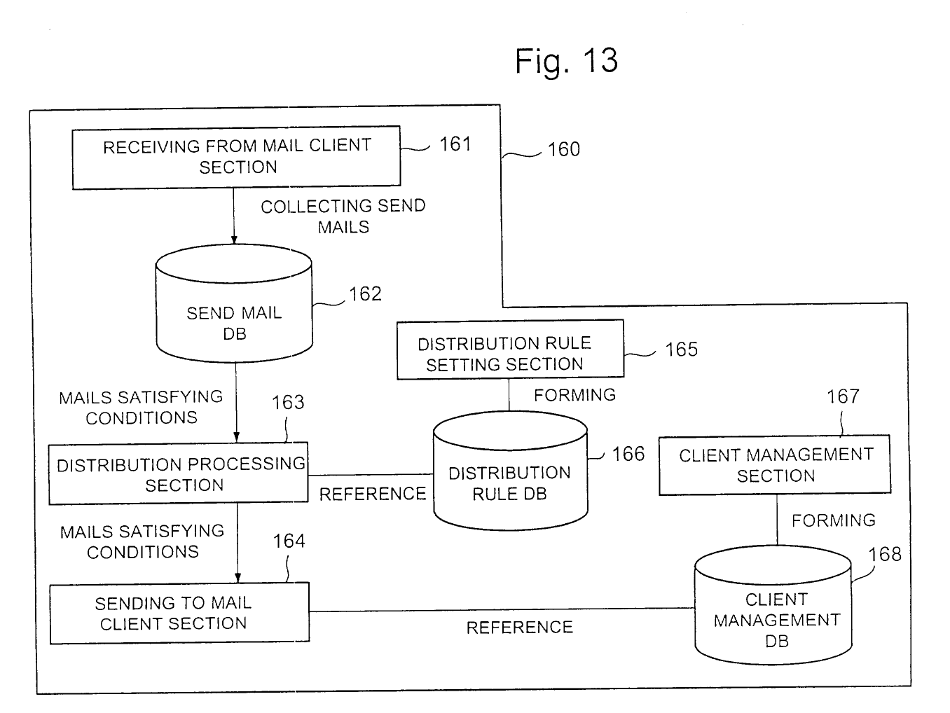

FIG. 13 is a detail block diagram showing the mail server device shown in FIG. 12.

A mail server device 160 in this figure has a configuration in which the distributing received-mail to client device 350 shown in FIG. 8 and a mail server provided using the computer 100 shown in FIG. 1 are combined.

The mail server device 160 in FIG. 13 is composed of a receiving from mail client section 161, a send mail DB 162, a distribution processing section 163, a sending to mail client section 164, a distribution rule setting section 165, a distribution rule DB 166, a client management section 167, and a client management DB 168. Among them, except for the receiving from mail client section 161 and the sending to mail client section 164, the send mail DB 162, the distribution processing section 163, the distribution rule setting section 165, the distribution rule DB 166, the client management section 167 and the client management DB 168 correspond to the received-mail database DB 352, the distribution processing section 353, the distribution rule setting section 355, the distribution rule DB 356, the client management section 357 and the client management DB 358 in the distributing received-mail to client device 350 shown in FIG. 8, respectively. Therefore, these sections will not be explained basically, and hereinafter, the receiving from mail client section 161 and the sending to mail client section 164 will be explained mainly.

The receiving from mail client section 161 receives send mails sent from a mail client to another mail client, and the received mails are stored in the send mail DB 162. Further, upon receiving a mail receiving request from a mail client, the receiving from mail client section 161 reads out from the send mail DB 162 “candidates” for mails to be sent to that mail client and passes them to the distribution processing section 163.

Like the description provided referring to FIG. 8, the distribution processing section 163 refers to the distribution rule DB 166 to select, according to the distribution rules stored in the distribution rule DB 166, from the received mails the mails to be sent to the mail client that gave a request for sending mails, and passes the selected mails to the sending to mail client section 164. The sending to mail client section 164 identifies the mail client referring to the client management DB 168, and sends the corresponding mails to the corresponding mail client.

As shown in FIG. 8, it is possible to provide a configuration in which a mail distribution device is combined with a mail server according to the present invention.

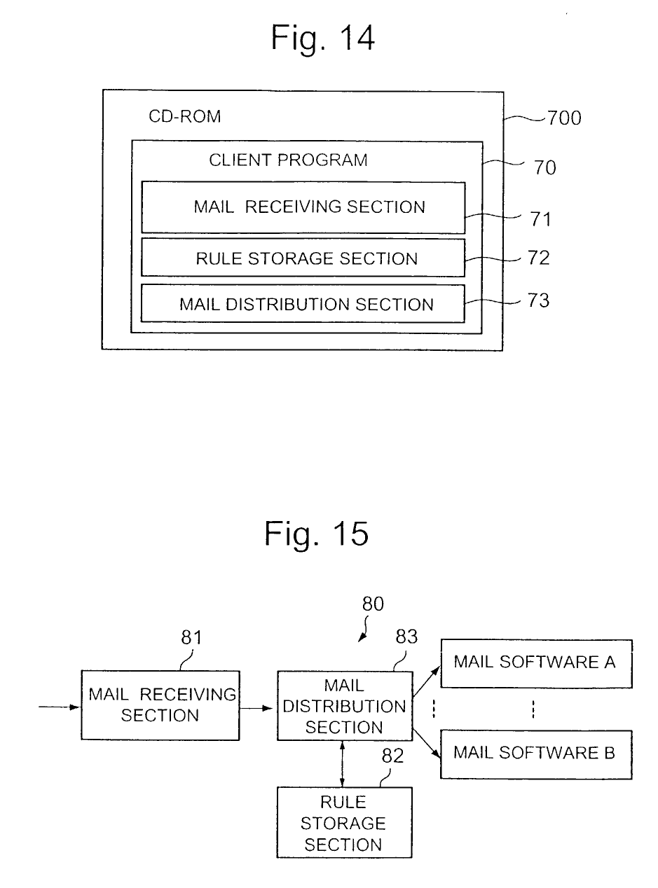

FIG. 14 is a schematic configuration diagram showing a client program stored in an embodiment of a client program storage medium according to the present invention.

A client program 70 shown in this figure has been stored in a CD-ROM 700 shown in FIG. 1, and is supposed to be installed in each of the computers 300, 400 and 500 except for the computer 100 operating as a mail server among the computers shown in FIG. 1. When the client program 70 shown in FIG. 14 is installed and executed in each of the computers 300, 400 and 500, each of these computers operates as an embodiment of the client device according to the present invention.

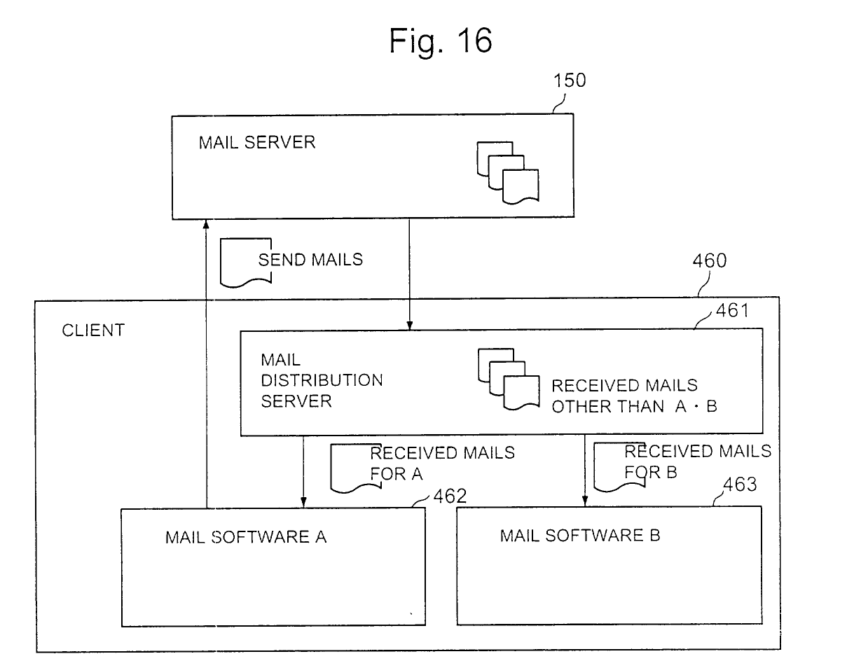

The client program 70 shown in FIG. 14 has a mail receiving section 71, a rule storage section 72, and a mail distribution section 73. Functions of these sections and those of the sections in the client device shown in FIG. 15 will be explained together.

Besides the client program 70 shown in FIG. 14, typically, plural types of store mailer (mail program) are installed in a computer (each of the computers 300, 400 and 500 shown in FIG. 1) in which the client program 70 is installed.

FIG. 15 is a functional block diagram showing an embodiment of a client device according to the present invention.

A client device 80 shown in FIG. 15 is configured in each of the computers 300, 400 and 500 shown in FIG. 1 as a result of that the client program 70 shown in FIG. 14 is installed and executed in each of these computers.

It is assumed that in a mailing system including the client device according to the present embodiment, a program for making the computer 100 shown in FIG. 1 operate as an ordinary mail server has been installed in the computer 100, and further that plural types of mailer (mail software A, . . . , B) besides the client program 70 shown in FIG. 14 have been installed in at least one, which function will be explained referring to FIG. 15, of the computers 300, 400 and 500 shown in FIG. 1.

The client device 80 shown in FIG. 15 has a mail receiving section 81, a rule storage section 82 and a mail distribution section 83. Also, plural types of mail software, A, . . . , B, have been installed in the client device 80.

The mail receiving section 81 has a function for receiving mails sent from a mail server.

The rule storage section 82 stores distribution rules for distributing the received mails to the plural types of mail software, A, . . . , B. As the distribution rules, rules like those in FIG. 9 can be adopted.

The mail distribution section 83 distributes the mails received by the mail receiving section 81 to each mail software, A, . . . , B, according to the distribution rules stored in the rule storage section 82.

As a result, the respective mail software, A, . . . , B can receive the desired mails only, according to the predetermined distribution rules.

FIG. 16 is a functional block diagram showing a mailing system including an embodiment of a client device according to the present invention.

A mail server 150 sends and receives mails to be sent from each client to other clients.

Also, a client 460 has therein a mail distribution server 461 and different types of mail software, mail software A462 and mail software B463.

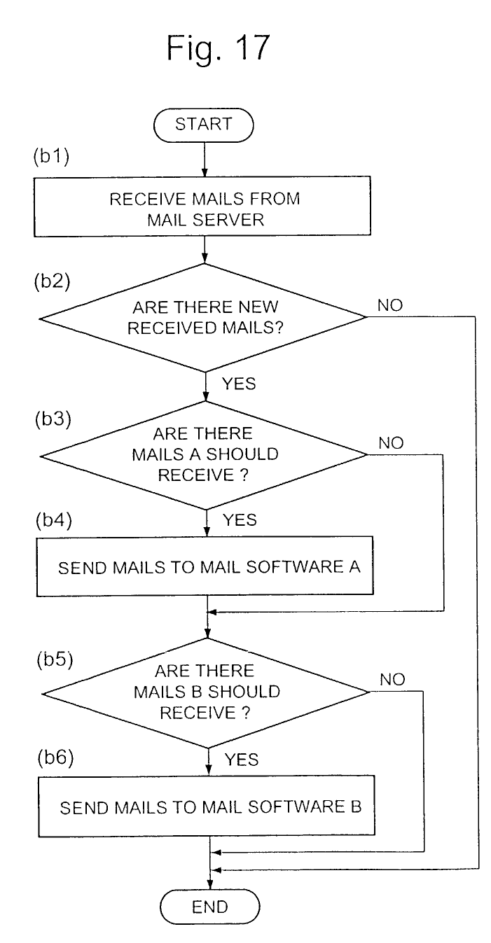

FIG. 17 is a flowchart showing an operation at the time of receiving mails, performed by the mail distribution server 461 within the client 460, in the mailing system shown in FIG. 16.

First, the processing for receiving mails from the mail server 150 is performed (step b1), and then it is determined whether there are new received mails or not (step b2). When there is no new received mail, the routine ends. When there are new received mails, subsequently, according to the distribution rules, it is determined whether there are mails that the mail software A should receive (step b3). If it is yes at step b3, the mails are sent to the mail software A (step b4). Similarly, according to the distribution rules, it is determined whether there are mails that the mail software B should receive (step b5). If it is yes at step b5, the mails are sent to the mail software B (step b6).

Accordingly, the mail software A and B can respectively receive the desired mails according to the distribution rules.

As described above, according to the present embodiment, it is possible to use plural types of mail software in one computer, and further, even when plural persons share one computer and one account name, each person can only receive mails addressed to each of them using each person's mail software.

What is claimed is:

1. A mail distribution device comprising:
a rule storage section storing distribution rules for distributing mails to plural pieces of mail software at least receiving mails; and
a mail distribution section distributing mails to each piece of mail software according to the distribution rules stored in the rule storage section.

2. A mail distribution device according to claim 1, wherein the rule storage section stores distribution rules including a discard rule for discarding mails without distribution, and
wherein the mail distribution section discards mails corresponding to the discard rule without distribution.

3. A mail distribution device comprising:
a mail receiving section receiving mails from a mail server;
a rule storage section storing distribution rules for distributing the received mails to plural clients at least receiving mails;
a mail distribution section distributing the mails received by the mail receiving section according to the distribution rules stored in the rule storage section to each client; and
a mail sending section sending the mails distributed by the mail distribution section to each client as a distribution destination.

4. A mail server device that processes mails comprising:
a rule storage section storing distribution rules for distributing mails to plural clients at least receiving mails, in which a distribution rule is associated with one receiver address;
a mail distribution section, for the time of sending mails having the same receiver address as that of the distribution rule stored in the rule storage section, distributing the mails to a client according to the distribution rule associated with the receiver address and stored in the rule storage section; and
a mail sending section sending the mails to the client to which the mails have been distributed by the mail distribution section.

5. A client device in which plural pieces of mail software at least receiving mails operate, comprising:
a rule storage section storing distribution rules for distributing mails to the plural pieces of mail software; and
a mail distribution section distributing the received mails to each mail software according to the distribution rules stored in the rule storage section.

6. A mail distribution program storage medium storing a mail distribution program that is executed in a computer and causes the computer to operate as a mail distribution device, the mail distribution device comprising:
a rule storage section storing distribution rules for distributing mails to plural pieces of mail software at least receiving mails; and
a mail distribution section distributing mails to each piece of mail software according to the distribution rules stored in the rule storage section.

7. A mail distribution program storage medium storing a mail distribution program according to claim 6, wherein the rule storage section stores distribution rules including a discard rule for discarding mails without distribution, and
wherein the mail distribution section discards mails corresponding to the discard rule without distribution.

8. A mail distribution program storage medium storing a mail distribution program that is executed in a computer and causes the computer to operate as a mail distribution device, wherein the mail distribution device comprising:
a mail receiving section receiving mails from a mail server;
a rule storage section storing distribution rules for distributing the received mails to plural pieces of mail software clients at least receiving mails;
a mail distribution section distributing the mails received by the mail receiving section according to the distribution rules stored in the rule storage section to each mail software; and
a mail sending section sending the mails distributed by the mail distribution section to each mail software as a distribution destination.

9. A mail server program storage medium storing a mail server program that is executed in a computer and causes the computer to operate as a mail server, wherein the mail server device comprising:
a rule storage section storing distribution rules for distributing mails to plural clients at least receiving mails, in which a distribution rule is associated with one receiver address;
a mail distribution section, for the time of sending mails having the same receiver address as that of the distribution rule stored in the rule storage section, distributing the mails to a client according to the distribution rule associated with the receiver address and stored in the rule storage section; and
a mail sending section sending the mails to the client to which the mails have been distributed.

10. A client program storage medium storing a client program that is executed in a computer and causes the computer to operate as a client, wherein the client device comprising:
a rule storage section storing distribution rules for distributing mails to the plural pieces of mail software; and
a mail distribution section distributing the received mails to each mail software according to the distribution rules stored in the rule storage section.
